(19) United States
(12) Patent Application Publication
(10) Pub. No.: US 2025/0308737 A1
(43) Pub. Date: Oct. 2, 2025

(54) COIL DEVICE

(71) Applicant: TDK CORPORATION, Tokyo (JP)

(72) Inventors: Kyosuke INUI, Tokyo (JP); Koji SHIMURA, Tokyo (JP); Hirofumi SASAKI, Tokyo (JP); Ryuji ANDO, Tokyo (JP)

(73) Assignee: TDK CORPORATION, Tokyo (JP)

(21) Appl. No.: 19/089,515

(22) Filed: Mar. 25, 2025

(30) Foreign Application Priority Data
Mar. 29, 2024 (JP) 2024-057777

(51) Int. Cl. H01F 3/10; H01F 5/06; H01F 17/04; H01F 27/28

(52) U.S. Cl. CPC H01F 3/10; H01F 5/06; H01F 17/045; H01F 27/2823; H01F 2003/106

(57) ABSTRACT

A coil device including: a first magnetic material portion containing a magnetic material and having a plate-shaped portion and a protrusion protruding from the plate-shaped portion; a wire having a winding portion including a conductor portion and an insulating coating portion covering the conductor portion and forming a winding layer wound around the protrusion; and a second magnetic material portion containing a magnetic material and a resin and covering at least the winding portion and the protrusion, in which a first layer uppermost wire cross section located farthest from the plate-shaped portion among wire cross sections included in a first layer directly wound around the protrusion in the winding portion includes a portion farther from the plate-shaped portion as compared with a protrusion tip, and the first layer uppermost wire cross section is in contact with the protrusion, in predetermined cross section in which the wire cross sections are observed.

### BACKGROUND OF THE INVENTION

### 1. Technical Field

The present invention relates to a coil device used as an inductor element or the like.

### 2. Description of the Related Art

As a coil device, a combination of two types of core portions having different content ratios of resin and magnetic material and a winding portion has been proposed. In such a coil device, by using two types of core portions having different content ratios of resin and magnetic material, it is possible to relax stress and prevent occurrence of cracks.

In such a coil device, a magnetic material is disposed so as to cover the winding portion, which is advantageous from the viewpoint of improving inductance. However, in such a coil device, particles constituting the core portion having a large resin content ratio among the two types of core portions and having fluidity may move into the winding portion at the time of compression or the like in the manufacturing process. During such movement of the particles, friction with the insulating coating of the wire constituting the winding portion may occur, and the insulating coating of the wire may be damaged.

### CITATION LIST

### Patent Literature

Patent Literature 1: JP 2017-199734 A
Patent Literature 2: JP 2020-113742 A

### SUMMARY OF THE INVENTION

The present disclosure has been made in view of such circumstances, and provides a coil device that prevents damage to a coating portion of a wire.

A coil device according to the present disclosure includes:
a first magnetic material portion containing a magnetic material and having a plate-shaped portion and a protrusion protruding from the plate-shaped portion;
a wire having a winding portion including a conductor portion and an insulating coating portion covering the conductor portion and forming a winding layer wound around the protrusion; and
a second magnetic material portion containing a magnetic material and a resin and covering at least the winding portion and the protrusion of the first magnetic material portion,
in which a first layer uppermost wire cross section located farthest from the plate-shaped portion among wire cross sections included in a first layer directly wound around the protrusion in the winding portion includes a portion farther from the plate-shaped portion as compared with a protrusion tip located farthest from the plate-shaped portion of the protrusion, and the coating portion in the first layer uppermost wire cross section is in contact with the protrusion, in a predetermined cross section including a winding axis of the winding portion in which the wire cross sections, which cross sections of the wire, are observed.

In the coil device according to the present disclosure, the first layer uppermost wire cross section can prevent particles of the second magnetic material portion from entering the inside of the winding portion and can suitably prevent damage of the wire and short circuit failure associated therewith.

For example, the protrusion tip may be farther from the plate-shaped portion as compared with a center of the first layer uppermost wire cross section.

By disposing the first layer uppermost wire cross section at such a position, it is possible to suitably prevent a problem that the position of the first layer uppermost wire cross section is shifted during compression or the like. In such a coil device, it is easy to form the winding portion at the time of manufacturing.

For example, a second layer uppermost wire cross section located farthest from the plate-shaped portion among the wire cross sections included in a second layer wound around the protrusion while overlapping the first layer in the winding portion may be closer to the plate-shaped portion than the first layer uppermost wire cross section.

The coil device having such a winding portion is less likely to cause winding collapse of the winding portion, and can more suitably prevent the magnetic material powder of the second magnetic material portion from entering the inside of the winding portion.

For example, the first layer uppermost wire cross section may be located farthest from the plate-shaped portion among all the wire cross sections included in the winding portion.

The coil device having such a winding portion is less likely to cause winding collapse of the winding portion, and can more suitably prevent the magnetic material powder or the like of the second magnetic material portion from moving into the winding portion.

For example, the first layer uppermost wire cross section may be closest to the winding axis among the wire cross sections included in the first layer.

For example, a protrusion side surface surrounding the periphery of the winding axis in the protrusion may be inclined so as to approach the winding axis as being farther from the plate-shaped portion, and the wire cross sections included in the first layer may be disposed along an inclination of the protrusion side surface.

In the coil device having such a winding portion, it is difficult to form a gap for the magnetic material powder of the second magnetic material portion to enter the inside of the winding portion in the periphery of the first layer uppermost wire cross section, and damage or the like of the coating portion of the wire can be more suitably prevented.

For example, a thickness of the second magnetic material portion covering the protrusion tip along a direction away from the plate-shaped portion may be twice or less an average diameter of the wire cross sections.

In such a coil device, since the thickness of the second magnetic material portion having a small content ratio of the magnetic material is thin, the magnetic characteristics of the core can be improved even if the coil device is small.

### BRIEF DESCRIPTION OF THE DRAWINGS

FIG. 1 is a partial perspective view of a coil device according to an embodiment of the present disclosure;

FIG. 2 is a cross-sectional view of the coil device illustrated in FIG. 1;

FIG. 3 is an enlarged cross-sectional view in which the periphery of a winding portion in the cross section illustrated in FIG. 2;

FIG. 4 is an enlarged schematic diagram of the periphery of a winding portion in a coil device according to a first modification;

FIG. 5 is an enlarged schematic diagram of the periphery of a winding portion in a coil device according to a second modification;

FIG. 6 is an enlarged schematic diagram of the periphery of a winding portion in a coil device according to a third modification;

FIG. 7 is an enlarged schematic diagram of the periphery of a winding portion in a coil device according to a fourth modification;

FIG. 8 is an enlarged schematic diagram of the periphery of a first layer of a winding portion in a coil device according to a fifth modification;

FIG. 9 is an enlarged schematic diagram of the periphery of a first layer of a winding portion in a coil device according to a sixth modification; and

FIGS. 10A to 10C are enlarged schematic diagrams of the periphery of a first layer uppermost wire cross section according to another modification.

### DETAILED DESCRIPTION

Hereinafter, embodiments of the present disclosure will be described with reference to the drawings. The illustrated contents are only schematically and exemplarily shown for understanding of the present disclosure, and the appearance, dimensional ratios, and the like may be different from the actual ones. The present disclosure is not limited to the following embodiments.

### First Embodiment

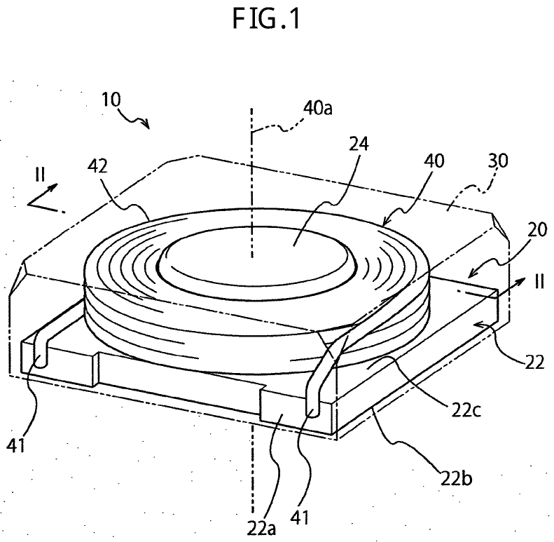

FIG. 1 is a partial perspective view of a coil device 10 according to an embodiment of the present disclosure. As illustrated in FIG. 1, the coil device 10 includes a first magnetic material portion 20, a second magnetic material portion 30, and a wire 40. The coil device 10 includes a pair of terminal electrodes (not illustrated in FIG. 1) connected to the wire 40. In FIG. 1, in order to understand an internal structure of the coil device 10, the second magnetic material portion 30 is displayed as an imaginary line in a see-through manner.

As illustrated in FIG. 1, the coil device 10 has a substantially rectangular parallelepiped outer shape, and the first magnetic material portion 20 is disposed near a bottom surface of the coil device 10. The first magnetic material portion 20 contains a magnetic material, and has a plate-shaped portion 22 having a substantially rectangular tabular shape and a columnar protrusion 24 protruding upward from a center portion of the plate-shaped portion 22.

The first magnetic material portion 20 includes, for example, a sintered core made of a magnetic material not containing a resin, a core containing a resin and a magnetic material formed by compression molding or injection molding granules containing a magnetic material powder constituting the magnetic material and a resin as a binder, and the like. The magnetic material powder is not particularly limited, and a metal magnetic material powder such as Sendust (Fe—Si—Al; iron-silicon-aluminum), Fe—Si—Cr (iron-silicon-chromium), Permalloy (Fe—Ni), carbonyl iron-based, carbonyl Ni-based, amorphous powder, or nanocrystal powder is preferably used.

However, the magnetic material powder may be a ferrite magnetic material powder such as Mn—Zn or Ni—Cu—Zn. When the first magnetic material portion 20 contains a magnetic material and a resin, a binder resin contained in the first magnetic material portion 20 is not particularly limited, and examples thereof include an epoxy resin, a phenol resin, an acrylic resin, a polyester resin, polyimide, polyamideimide, a silicon resin, and a combination thereof.

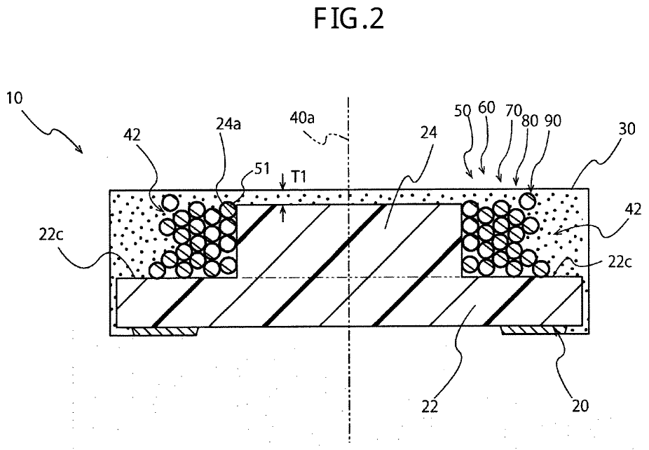

As illustrated in FIG. 2 which is a cross-sectional view, the first magnetic material portion 20 functions as a core in the coil device 10 together with the second magnetic material portion 30 described later. The plate-shaped portion 22 has a larger projected area than the protrusion 24 when viewed from above. The thickness of the plate-shaped portion 22 can be set to about 10 to 40% of the total thickness of the coil device 10, but is not particularly limited. The shape of the plate-shaped portion 22 is not limited only to the substantially rectangular tabular shape, and may be a shape other than the rectangular tabular shape, such as a polygonal plate shape, a circular plate shape, or an elliptical plate shape.

The protruding height of the protrusion 24 is also not particularly limited, but can be set to about 20 to 60% of the total thickness of the coil device 10. The outer peripheral shape of the protrusion 24 illustrated in FIG. 1 is not limited to a circular shape, and may be a shape other than the circular shape, such as an elliptical shape or a polygonal shape, but is preferably a circular shape or an elliptical shape from the viewpoint of winding the wire 40 in close contact with the outer periphery of the protrusion 24.

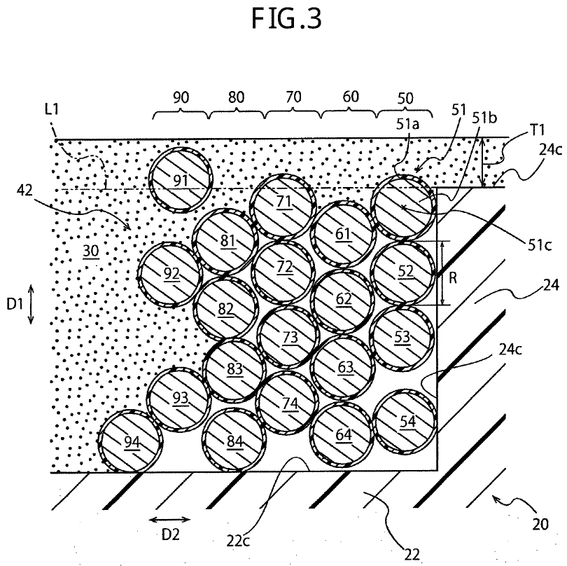

As illustrated in FIG. 1, the wire 40 has a winding portion 42 that forms two or more winding layers wound around the protrusion 24, and a wire end portion 41 drawn out from the winding portion 42. As illustrated in FIG. 3 which is an enlarged cross-sectional view, the wire 40 has a conductive conductor portion (see a conductor portion 51b of FIG. 3 or the like) and an insulating coating portion (see a coating portion 51a of FIG. 3 or the like) covering the conductor portion. In the winding portion 42 in a predetermined cross section as illustrated in FIGS. 2 and 3, a coating portion appears in the outer peripheral portion of a wire cross section (see a first layer uppermost wire cross section 51 of FIG. 3 or the like).

The conductor portion of the wire 40 is made of, for example, Cu, Al, Fe, Ag, Au, phosphor bronze, or the like. Examples of the material of the coating portion formed on the surface of the conductor portion of the wire 40 include polyurethane, polyamideimide, polyimide, polyester, polyester-imide, and polyester-nylon.

A part of the wire 40 is wound around the protrusion 24 to form the winding portion 42. FIG. 2 is a cross-sectional view taken along a predetermined cross section including a winding axis 40a of the winding portion 42, and in FIG. 3 which is a partially enlarged view thereof, wire cross sections 51 to 54, 61 to 64, 71 to 74, 81 to 84, and 91 to 94 which are cross sections of the wire 40 are observed for the number of windings of the wire 40 around the protrusion 24. Although the number of windings of the wire 40 around the protrusion 24 in the coil device 10 illustrated in FIGS. 2 and 3 is 20 turns, the number of windings of the winding portion 42 is not particularly limited.

As illustrated in FIG. 2, the winding portion 42 forms two or more winding layers, and in the embodiment, the winding layers of a first layer 50, a second layer 60, a third layer 70, a fourth layer 80, and a fifth layer 90 are formed. The first to fifth layers 50 to 90 are arranged along a second direction D2 perpendicular to the winding axis 40a. The first layer 50 is directly wound around the protrusion 24, for example, by being pressed against a protrusion side surface 24a of the protrusion 24. The second layer 60 is pressed against the first layer 50 on the inner peripheral side and wound, for example. Similarly to the second layer 60, the third layer 70, the fourth layer 80, and the fifth layer 90 are also pressed against the winding layer on the inner peripheral side and wound. The wire cross sections 51 to 54, 61 to 64, 71 to 74, 81 to 84, and 91 to 94 adjacent to each other in the winding portion 42 are in close contact with each other by fusion of the coating portion or the like. However, a local gap may be formed between the wire cross sections 51 to 54, 61 to 64, 71 to 74, 81 to 84, and 91 to 94 by spring back of the wire 40 or the like.

As described above, the winding portion 42 is preferably formed by winding the wire 40 around the winding portion 42 with a winding machine or the like, so that the first layer 50 of the winding portion 42 is in contact with the protrusion 24 or the first to fifth layers 50 to 90 are in contact with each other from the viewpoint of increasing the winding density. However, the winding portion 42 may be formed of an air-core coil. The number of winding layers included in the winding portion 42 is also not particularly limited, and any two or more winding layers can be formed around the winding portion 42. In the winding portion 42, all the winding layers may be pressed against the inner winding layer and wound, or a part or all of the winding layers may be wound with a space from the winding layers on the inner peripheral side.

As illustrated in FIG. 2, the wire 40 is a round wire in which the wire cross sections 51 to 54, 61 to 64, 71 to 74, 81 to 84, and 91 to 94 are substantially circular. However, the wire 40 is not limited to only a round wire, and a rectangular wire having a substantially rectangular cross section may be used. The wire 40 is not limited to only a single wire in which the conductor portion 51b and the coating portion 51a are concentrically formed, and may have conductor portions such as a stranded wire.

As illustrated in FIG. 1, the wire 40 has a pair of wire end portions 41 drawn out from both ends of the winding portion 42, and each wire end portion 41 is connected to a terminal electrode portion (not illustrated) formed on a plate-shaped portion side surface 22a and a plate-shaped portion bottom surface 22b of the plate-shaped portion 22. The terminal electrode portion may be, for example, a metal terminal such as copper or a copper alloy bonded to the plate-shaped portion 22, a baked electrode containing silver, a silver alloy, or the like, or a metal film electrode formed by plating or the like.

As illustrated in FIG. 2, the second magnetic material portion 30 covers at least the winding portion 42 of the wire 40 and the protrusion 24 of the first magnetic material portion 20 and constitutes the core of the coil device 10 together with the first magnetic material portion 20. The second magnetic material portion 30 contains a magnetic material and a resin. The second magnetic material portion 30 contains a magnetic material similarly to the first magnetic material portion 20, but the content ratio of the magnetic material is smaller than that of the first magnetic material portion 20. Since the content ratio of the magnetic material is small, the second magnetic material portion 30 can be disposed around the winding portion 42 in a state of having fluidity at the time of manufacturing, whereby the second magnetic material portion 30 can be brought into close contact with the winding portion 42 from the outer peripheral side and the upper side without any gap.

As the magnetic material contained in the second magnetic material portion 30, a metal magnetic material powder or ferrite magnetic material powder similar to those exemplified as the magnetic material powder contained in the first magnetic material portion 20 can be used. Examples of the binder resin contained in the second magnetic material portion 30 include an epoxy resin, a phenol resin, an acrylic resin, a polyester resin, polyimide, polyamideimide, a silicon resin, and a combination thereof, as with the first magnetic material portion 20.

The second magnetic material portion 30 is combined with the first magnetic material portion 20 having only one plate-shaped portion 22 as illustrated in FIGS. 1 and 2, and is disposed not only on the outer peripheral side of the winding portion 42 but also on the upper side of the winding portion 42 and the upper side of the protrusion 24.

The second magnetic material portion 30 is manufactured by compression molding or the like. For example, the second magnetic material portion 30 is obtained by putting an intermediate product in which the winding portion 42 is formed by the wire 40 around the protrusion 24 of the first magnetic material portion 20 and a mixture of the magnetic material powder and the binder resin to be the material of the second magnetic material portion 30 into a cavity and compressing the whole.

The content ratio of the magnetic material in the second magnetic material portion 30 is preferably 50% or more from the viewpoint of improving inductance, and more preferably 70% or more. The magnetic material contained in the second magnetic material portion 30 may be composed of two or more types of magnetic material powder having different mean particle diameters. In such a second magnetic material portion 30, since the particle diameter distribution of the magnetic material powder has peaks and is distributed in a wide range, the magnetic material powder having a small particle size easily enters the inter-wire gap.

FIG. 3 is an enlarged cross-sectional view illustrating a predetermined cross section including the winding axis 40a of the winding portion 42 illustrated in FIG. 2, and the wire cross sections 51 to 54, 61 to 64, 71 to 74, 81 to 84, and 91 to 94 which are cross sections of the wire 40 are observed. In FIG. 3, the wire cross sections 51 to 54, 61 to 64, 71 to 74, 81 to 84, and 91 to 94 which are cross sections of the wire 40 can be observed by the number corresponding to the number of windings (20 turns) of the wire 40 around the protrusion 24.

As illustrated in FIG. 3, the first layer 50 directly wound around the protrusion 24 in the winding portion 42 includes four wire cross sections 51 to 54 of a first layer uppermost wire cross section 51, a first layer second-stage wire cross section 52, a first layer third-stage wire cross section 53, and a first layer fourth-stage wire cross section 54. The first layer uppermost wire cross section 51 is a wire cross section, which is located farthest from the plate-shaped portion 22, among the wire cross sections 51 to 54 included in the first layer 50. The first layer 50 means a layer including the wire cross sections 51 to 54 facing the protrusion 24 without sandwiching another wire cross section, and may correspond to the first layer 50 directly wound around the protrusion 24 regardless of whether the wire 40 is formed by winding a wire serving as a raw material around the protrusion 24 to form the winding portion 42 or whether the wire 40 uses an air-core coil.

The first layer uppermost wire cross section 51 includes a portion farther from the plate-shaped portion 22 as compared with a protrusion tip 24c located farthest from the plate-shaped portion 22 of the protrusion 24 of the first magnetic material portion 20. That is, in FIG. 3, the first layer uppermost wire cross section 51 has a portion protruding upward, which is the protruding direction of the protrusion 24, from a straight line L1 passing through the protrusion tip 24c and parallel to a plate-shaped portion upper surface 22c. The first layer uppermost wire cross section 51 illustrated in FIG. 3 protrudes upward from the straight line L1 by about 20% of the diameter of the wire cross section in a first direction D1 farther from the plate-shaped portion 22. However, the arrangement of the first layer uppermost wire cross section 51 is not limited only to the example illustrated in FIG. 3.

The coating portion 51a in the first layer uppermost wire cross section 51 is in contact with the protrusion 24. Since the first layer uppermost wire cross section 51 is in contact with the protrusion 24, it is possible to prevent the magnetic material contained in the second magnetic material portion 30 from entering the winding portion 42 from the winding portion 42 and the second magnetic material portion 30 on the upper side of the protrusion 24. Since the first layer uppermost wire cross section 51 is in contact with the protrusion 24 and protrudes upward from the straight line L1, the first layer uppermost wire cross section 51 is suitably pressed against the protrusion 24 during compression molding or the like, and a problem that a temporary gap that allows passage of the magnetic material powder is formed between the first layer uppermost wire cross section 51 and the protrusion 24 can be prevented.

As illustrated in FIG. 3, the protrusion tip 24c is farther from the plate-shaped portion 22 as compared with a center 51c of the first layer uppermost wire cross section 51. That is, the proportion at which the first layer uppermost wire cross section 51 protrudes upward from the straight line L1 is less than 50% of the diameter of the wire cross section. By disposing the first layer uppermost wire cross section 51 in this manner, it is possible to reduce the possibility that the contact between the first layer uppermost wire cross section 51 and the protrusion 24 is unintentionally released when the pressure during compression molding is increased.

The first layer second-stage wire cross section 52 illustrated in FIG. 3 is disposed on the lower side (plate-shaped portion 22 side) of the first layer uppermost wire cross section 51, the first layer third-stage wire cross section 53 is disposed on the lower side (plate-shaped portion 22 side) of the first layer second-stage wire cross section 52, and the first layer fourth-stage wire cross section 54 is disposed on the lower side (plate-shaped portion 22 side) of the first layer third-stage wire cross section 53. The layers 50 to 90 of the winding portion 42 in the wire 40 are configured by the wire cross sections 51 to 54, 61 to 64, 71 to 74, 81 to 84, and 91 to 94 wound by four turns along the winding axis 40a (see FIG. 2), respectively.

As illustrated in FIG. 3, the second layer 60 wound around the protrusion 24 while overlapping the first layer 50 in the winding portion 42 includes four wire cross sections 61 to 64 of a second layer uppermost wire cross section 61, a second layer second-stage wire cross section 62, a second layer third-stage wire cross section 63, and a second layer fourth-stage wire cross section 64. The second layer uppermost wire cross section 61 is a wire cross section, which is located farthest from the plate-shaped portion 22, among the wire cross sections 61 to 64 included in the second layer 60.

The second layer uppermost wire cross section 61 of the second layer 60 is disposed closer to the plate-shaped portion 22 than the first layer uppermost wire cross section 51 of the first layer 50 adjacent to the side closer to the protrusion 24. With such an arrangement, it is possible to reduce the possibility that the position of the second layer uppermost wire cross section 61 is unintentionally displaced when the pressure during compression molding is increased.

As illustrated in FIG. 3, the third layer 70 wound around the protrusion 24 while overlapping the second layer 60 in the winding portion 42 includes four wire cross sections 71 to 74 of a third layer uppermost wire cross section 71, a third layer second-stage wire cross section 72, a third layer third-stage wire cross section 73, and a third layer fourth-stage wire cross section 74. The fourth layer 80 wound around the protrusion 24 while overlapping the third layer 70 in the winding portion 42 includes four wire cross sections 81 to 84 of a fourth layer uppermost wire cross section 81, a fourth layer second-stage wire cross section 82, a fourth layer third-stage wire cross section 83, and a fourth layer fourth-stage wire cross section 84. Similarly, the fifth layer 90 includes four wire cross sections 91 to 94.

In the first to fourth layers 50 to 80 excluding the fifth layer 90 which is the outermost layer, the first to fourth layer uppermost wire cross sections 51 to 81 are disposed in a zigzag manner. That is, the second and fourth layer uppermost wire cross sections 61 and 81 are disposed closer to the plate-shaped portion 22 than the first and third layer uppermost wire cross sections 51 and 71. The shape of such a winding portion 42 is preferable from the viewpoint of preventing winding collapse of each wire cross section during compression molding or the like and preventing movement of the magnetic material powder into the winding portion 42.

As illustrated in FIGS. 2 and 3, in the coil device 10, a thickness Tl of the second magnetic material portion 30 covering the protrusion tip 24c along the first direction D1, which is a direction away from the plate-shaped portion 22, is preferably twice or less a diameter R (average diameter when the diameter is not constant) of the wire cross sections 51 to 54, 61 to 64, 71 to 74, 81 to 84, and 91 to 94. In this way, the coil device 10 can be thinned, and the proportion of the first magnetic material portion 20 of the entire deposition of the coil device 10 can be increased to improve the performance of the coil device 10 such as inductance.

As described above, since the first layer uppermost wire cross section 51 is in contact with the protrusion 24 and protrudes upward from the straight line L1, the coil device 10 can prevent the magnetic material powder or the like of the second magnetic material portion 30 outside the winding portion 42 from entering the winding portion 42. Accordingly, the coil device 10 can suitably prevent the damage of the coating portion of the wire 40 and the short circuit failure associated therewith.

In the coil device 10, it is particularly important to suitably maintain the adhesion between the first layer uppermost wire cross section 51 and the protrusion 24 from the viewpoint of preventing the magnetic material powder from entering the winding portion 42 from the second magnetic material portion 30. The reason is that, for example, the pressurizing direction during compression molding of the coil device 10 as illustrated in FIG. 2 is often the vertical direction (first direction D1), and thus, the moving distance of the particles in the first direction D1 increases. Adhesion between the wire cross sections 51 to 54, 61 to 64, 71 to 74, 81 to 84, and 91 to 94 is relatively easily maintained by contact between the flexible coating portions 51a, and it is also possible to prevent passage of particles by performing a fusion treatment between the coating portions.

As described above, the coil device 10 can prevent the second magnetic material portion 30 from moving from the outside to the inside of the winding portion 42 during compression molding, and can suitably prevent the coating portion of the wire 40 from being damaged.

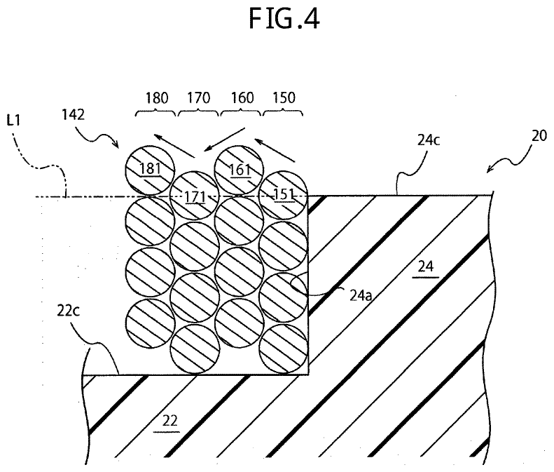

FIG. 4 is an enlarged schematic diagram of the periphery of a winding portion 142 in a coil device according to a first modification. The coil device according to the first modification is similar to the coil device 10 according to the first embodiment except for the shape of the winding portion 142. Regarding the coil device according to the first modification, only differences from the coil device 10 will be described. In FIG. 4, wire cross sections 151, 161, 171, and 181 simply represent only the outer shape, and the second magnetic material portion 30 is not illustrated.

As illustrated in FIG. 4, the winding portion 142 has a first layer 150, a second layer 160, a third layer 170, and a fourth layer 180. Each of the layers 150, 160, 170, and 180 is configured by wire cross sections wound by four turns. The first layer 150 is directly wound around the protrusion 24 in the winding portion 42. The first layer 150 has a first layer uppermost wire cross section 151, which is a wire cross section located farthest from the plate-shaped portion 22, among the wire cross sections included in the first layer 150.

The second layer 160 is wound so as to overlap the outer peripheral side of the first layer 150 in the winding portion 142, and has a second layer uppermost wire cross section 161 which is a wire cross section located farthest from the plate-shaped portion 22 among the wire cross sections included in the second layer 160. The third layer 170 is wound so as to overlap the outer peripheral side of the second layer 160 in the winding portion 142, and has a third layer uppermost wire cross section 171 which is a wire cross section located farthest from the plate-shaped portion 22 among the wire cross sections included in the third layer 170. The fourth layer 180 is wound so as to overlap the outer peripheral side of the third layer 170 in the winding portion 142, and has a fourth layer uppermost wire cross section 181 which is a wire cross section located farthest from the plate-shaped portion 22 among the wire cross sections included in the fourth layer 180.

In the first to fourth layers 150 to 180, the first to fourth layer uppermost wire cross sections 151 to 181 are disposed in a zigzag manner. That is, the first and third layer uppermost wire cross sections 151 and 171 are disposed closer to the plate-shaped portion 22 than the second and fourth layer uppermost wire cross sections 161 and 181. The shape of such a winding portion 142 is preferable from the viewpoint of preventing the positional displacement of each of the wire cross sections 151 to 154 and 171 to 174 during compression molding or the like.

In the coil device according to the present disclosure, a wire having the winding portion 142 illustrated in FIG. 4 can be adopted instead of the winding portion 42 illustrated in FIG. 1. Other than, the coil device according to the modification has the same effects as those of the coil device 10 in terms of common points with the coil device 10.

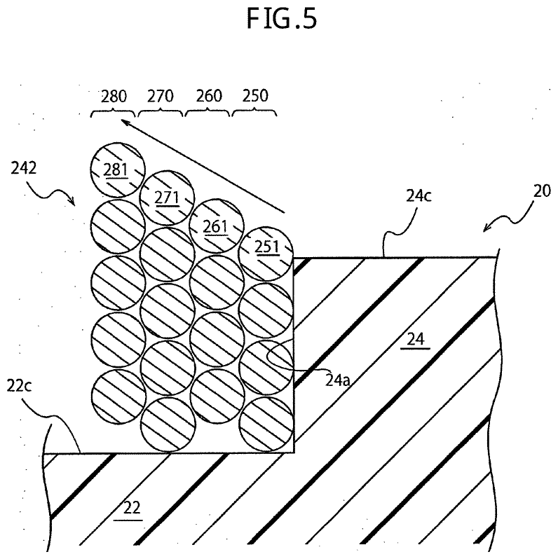

FIG. 5 is an enlarged schematic diagram of the periphery of a winding portion 242 in a coil device according to a second modification. The coil device according to the second modification is similar to the coil device 10 according to the first embodiment except for the shape of the winding portion 242. Regarding the coil device according to the second modification, only differences from the coil device 10 will be described. In FIG. 5, wire cross sections 251, 261, 271, and 281 simply represent only the outer shape, and the second magnetic material portion 30 is not illustrated.

As illustrated in FIG. 5, the winding portion 242 has a first layer 250, a second layer 260, a third layer 270, and a fourth layer 280. The first layer 250 and the second layer 260 are configured by wire cross sections wound by four turns, and the third layer 270 and the fourth layer 280 are configured by wire cross sections wound by five turns. The first layer 250 is directly wound around the protrusion 24. The first layer 250 has a first layer uppermost wire cross section 251, which is a wire cross section located farthest from the plate-shaped portion 22, among the wire cross sections included in the first layer 250.

The second layer 260 is wound so as to overlap the outer peripheral side of the first layer 250 in the winding portion 242, and has a second layer uppermost wire cross section 261 which is a wire cross section located farthest from the plate-shaped portion 22 among the wire cross sections included in the second layer 260. The third layer 270 is wound so as to overlap the outer peripheral side of the second layer 260 in the winding portion 242, and has a third layer uppermost wire cross section 271 which is a wire cross section located farthest from the plate-shaped portion 22 among the wire cross sections included in the third layer 270. The fourth layer 280 is wound so as to overlap the outer peripheral side of the third layer 270 in the winding portion 242, and has a fourth layer uppermost wire cross section 281 which is a wire cross section located farthest from the plate-shaped portion 22 among the wire cross sections included in the fourth layer 280.

In the first to fourth layers 250 to 280, the first to fourth layer uppermost wire cross sections 251 to 281 are disposed to be inclined so as to be farther from the plate-shaped portion 22 as being farther from the winding axis 40a (see FIGS. 1 and 2). The shape of such a winding portion 242 makes it possible to increase the total number of turns of the winding portion 242 while preventing damage to the coating portion of the wire even when the protrusion 24 having a short protruding length in the first direction D1 is used.

In the coil device according to the present disclosure, a wire having the winding portion 242 illustrated in FIG. 5 can be adopted instead of the winding portion 42 illustrated in FIG. 1. Other than, the coil device according to the modification has the same effects as those of the coil device 10 in terms of common points with the coil device 10.

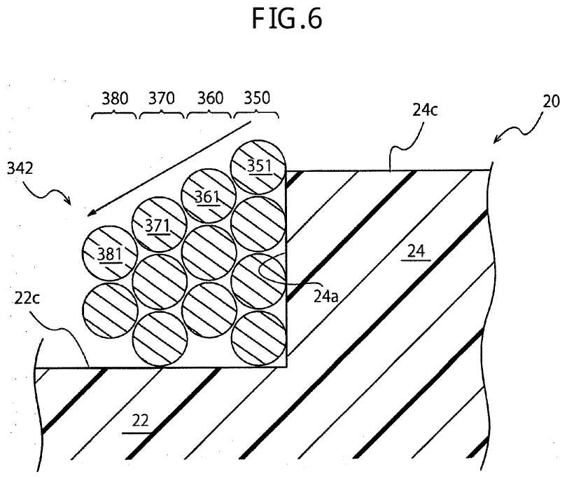

FIG. 6 is an enlarged schematic diagram of the periphery of a winding portion 342 in a coil device according to a third modification. The coil device according to the third modification is similar to the coil device 10 according to the first embodiment except for the shape of the winding portion 342. Regarding the coil device according to the third modification, only differences from the coil device 10 will be described. In FIG. 6, wire cross sections 351, 361, 371, and 381 simply represent only the outer shape, and the second magnetic material portion 30 is not illustrated.

As illustrated in FIG. 6, the winding portion 342 has a first layer 350, a second layer 360, a third layer 370, and a fourth layer 380. The first layer 350 is configured by a wire cross section wound by four turns, the second layer 360 and the third layer 370 are configured by wire cross sections wound by three turns, and the fourth layer 380 is configured by a wire cross section wound by two turns. The first layer 350 is directly wound around the protrusion 24. The first layer 350 has a first layer uppermost wire cross section 351, which is a wire cross section located farthest from the plate-shaped portion 22, among the wire cross sections included in the first layer 350.

The second layer 360 is wound so as to overlap the outer peripheral side of the first layer 350 in the winding portion 342, and has a second layer uppermost wire cross section 361 which is a wire cross section located farthest from the plate-shaped portion 22 among the wire cross sections included in the second layer 360. The third layer 370 is wound so as to overlap the outer peripheral side of the second layer 360 in the winding portion 342, and has a third layer uppermost wire cross section 371 which is a wire cross section located farthest from the plate-shaped portion 22 among the wire cross sections included in the third layer 370. The fourth layer 380 is wound so as to overlap the outer peripheral side of the third layer 370 in the winding portion 342, and has a fourth layer uppermost wire cross section 381 which is a wire cross section located farthest from the plate-shaped portion 22 among the wire cross sections included in the fourth layer 380.

In the first to fourth layers 350 to 380, the first to fourth layer uppermost wire cross sections 351 to 381 are disposed to be inclined so as to approach the plate-shaped portion 22 as being farther from the winding axis 40a (see FIGS. 1 and 2). The first layer uppermost wire cross section 351 is located farthest from the plate-shaped portion 22 among all the wire cross sections included in the winding portion 342. The shape of such a winding portion 342 is effective from the viewpoint of preventing winding collapse and preventing damage to the coating portion of the wire.

In the coil device according to the present disclosure, a wire having the winding portion 342 illustrated in FIG. 6 can be adopted instead of the winding portion 42 illustrated in FIG. 1. Other than, the coil device according to the modification has the same effects as those of the coil device 10 in terms of common points with the coil device 10.

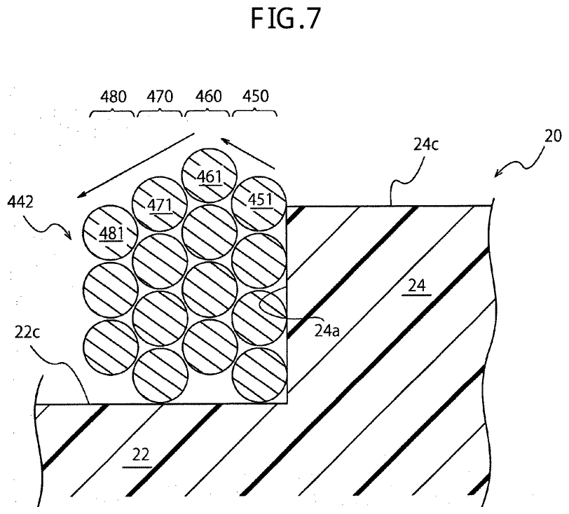

FIG. 7 is an enlarged schematic diagram of the periphery of a winding portion 442 in a coil device according to a fourth modification. The coil device according to the fourth modification is similar to the coil device 10 according to the first embodiment except for the shape of the winding portion 442. Regarding the coil device according to the fourth modification, only differences from the coil device 10 will be described. In FIG. 7, wire cross sections 451, 461, 471, and 481 simply represent only the outer shape, and the second magnetic material portion 30 is not illustrated.

As illustrated in FIG. 7, the winding portion 442 has a first layer 450, a second layer 460, a third layer 470, and a fourth layer 480. The first layer 450, the second layer 460, and the third layer 470 are configured by wire cross sections wound by four turns, and the fourth layer 480 is configured by a wire cross section wound by three turns. The first layer 450 is directly wound around the protrusion 24. The first layer 450 has a first layer uppermost wire cross section 451, which is a wire cross section located farthest from the plate-shaped portion 22, among the wire cross sections included in the first layer 450.

The second layer 460 is wound so as to overlap the outer peripheral side of the first layer 450 in the winding portion 442, and has a second layer uppermost wire cross section 461 which is a wire cross section located farthest from the plate-shaped portion 22 among the wire cross sections included in the second layer 460. The third layer 470 is wound so as to overlap the outer peripheral side of the second layer 460 in the winding portion 442, and has a third layer uppermost wire cross section 471 which is a wire cross section located farthest from the plate-shaped portion 22 among the wire cross sections included in the third layer 470. The fourth layer 480 is wound so as to overlap the outer peripheral side of the third layer 470 in the winding portion 442, and has a fourth layer uppermost wire cross section 481 which is a wire cross section located farthest from the plate-shaped portion 22 among the wire cross sections included in the fourth layer 480.

The second layer uppermost wire cross section 461 of the second layer 460 is disposed so as to be farther from the plate-shaped portion 22 as compared with the first layer uppermost wire cross section 451 of the first layer 450. In the second to fourth layers 460 to 480, the second to fourth layer uppermost wire cross sections 461, 471, and 481 are disposed to be inclined so as to approach the plate-shaped portion 22 as being farther from the winding axis 40a (see FIGS. 1 and 2). The shape of such a winding portion 342 has an effect of increasing the number of windings while preventing winding collapse.

In the coil device according to the present disclosure, a wire having the winding portion 442 illustrated in FIG. 7 can be adopted instead of the winding portion 42 illustrated in FIG. 1. Other than, the coil device according to the modification has the same effects as those of the coil device 10 in terms of common points with the coil device 10.

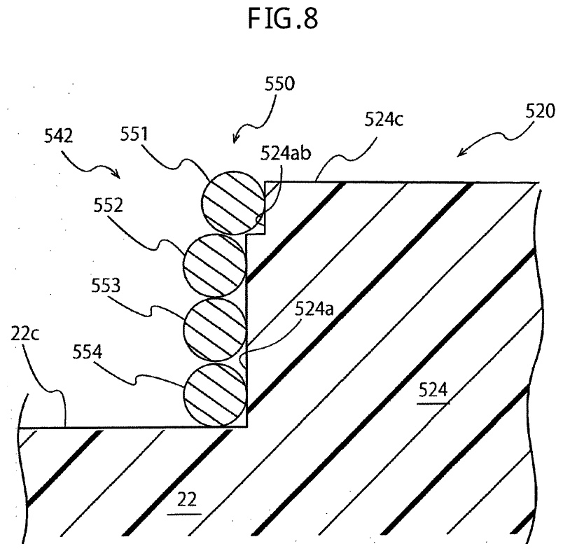

FIG. 8 is an enlarged schematic diagram of the periphery of a winding portion 542 in a coil device according to a fifth modification. The coil device according to the fifth modification is similar to the coil device 10 according to the first embodiment except that the shape of the winding portion 542 is different from the shape of a protrusion 524 of a first magnetic material portion 520. Regarding the coil device according to the fifth modification, only differences from the coil device 10 will be described. In FIG. 8, only a first layer 550 of the winding portion 542 is illustrated. Wire cross sections 551 to 554 simply represent only the outer shape, and the second magnetic material portion 30 is not illustrated.

As illustrated in FIG. 8, the protrusion 524 in the first magnetic material portion 520 has a step surface 524ab formed at a connection portion of a protrusion side surface 524a with a protrusion tip 524c. A first layer uppermost wire cross section 551, which is a wire cross section located farthest from the plate-shaped portion 22, of the first layer 550 of the winding portion 542 is provided on the step surface 524ab.

The first layer uppermost wire cross section 551 is disposed at a position closest to the winding axis 40a (see FIGS. 1 and 2) among the wire cross sections 551, 552, 553, and 554 included in the first layer 550. The shape of such a winding portion 542 can suitably prevent a problem that the position of the first layer uppermost wire cross section 551 is shifted during compression molding or the like.

In the coil device according to the present disclosure, a wire having the winding portion 542 illustrated in FIG. 8 can be adopted instead of the winding portion 42 illustrated in FIG. 1. Other than, the coil device according to the modification has the same effects as those of the coil device 10 in terms of common points with the coil device 10.

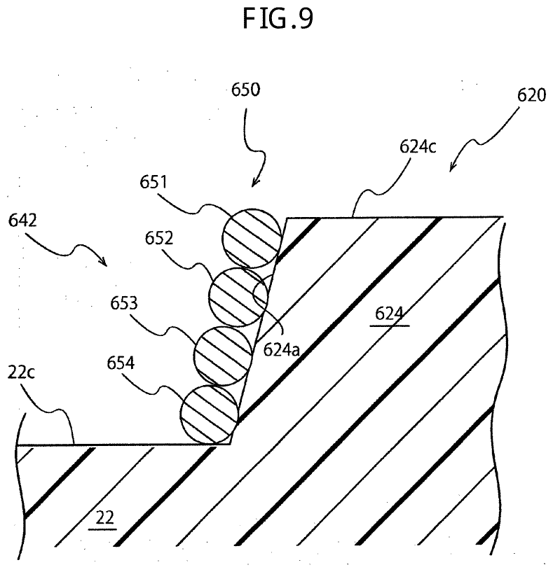

FIG. 9 is an enlarged schematic diagram of the periphery of a winding portion 642 in a coil device according to a sixth modification. The coil device according to the sixth modification is similar to the coil device 10 according to the first embodiment except that the shape of the winding portion 642 is different from the shape of a protrusion 624 of a first magnetic material portion 620. Regarding the coil device according to the sixth modification, only differences from the coil device 10 will be described. In FIG. 9, only a first layer 650 of the winding portion 642 is illustrated. Wire cross sections 651 to 654 simply represent only the outer shape, and the second magnetic material portion 30 is not illustrated.

As illustrated in FIG. 9, in the first magnetic material portion 620, a protrusion side surface 624a surrounding the periphery of the winding axis 40a (see FIGS. 1 and 2) in the protrusion 624 is inclined so as to approach the winding axis 40a as it is farther from the plate-shaped portion 22 and approaches a protrusion tip 624c. The wire cross sections 651, 652, 653, and 654 included in the first layer 650 are disposed along the inclination of the protrusion side surface 624a.

The first layer uppermost wire cross section 651 is disposed at a position closest to the winding axis 40a (see FIGS. 1 and 2) among the wire cross sections 651 to 654 included in the first layer 650. The shape of such a winding portion 642 can suitably prevent a problem that the position of the first layer uppermost wire cross section 651 is shifted during compression molding or the like.

In the coil device according to the present disclosure, a wire having the winding portion 542 illustrated in FIG. 8 can be adopted instead of the winding portion 42 illustrated in FIG. 1. Other than, the coil device according to the modification has the same effects as those of the coil device 10 in terms of common points with the coil device 10. The present disclosure is not limited to the above-described embodiments and examples, and various modifications can be made within the scope of the present disclosure.

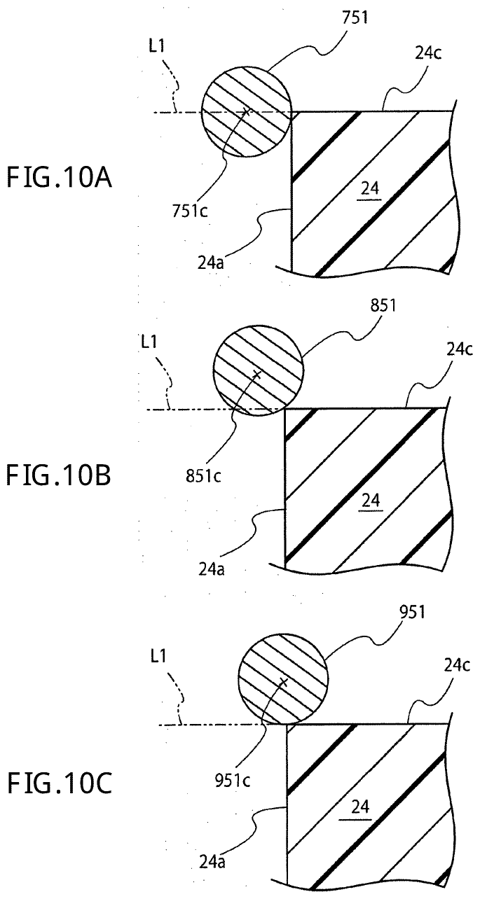

For example, as illustrated in FIGS. 10A to 10C, the contact state of first layer uppermost wire cross sections 751 to 951 with respect to the protrusion 24 is not limited only to those illustrated in embodiments and modifications. In the first layer uppermost wire cross section 751 illustrated in FIG. 10A, a center 751c is located on the straight line L1 passing through the protrusion tip 24c and parallel to the plate-shaped portion upper surface 22c.

In the first layer uppermost wire cross section 851 illustrated in FIG. 10B, a center 851c is located above the straight line L1 passing through the protrusion tip 24c and parallel to the plate-shaped portion upper surface 22c. In the first layer uppermost wire cross section 951 illustrated in FIG. 10C, a center 951c is located on the extension line of the protrusion side surface 24a. By disposing the first layer uppermost wire cross sections 751, 851, and 951 at the positions illustrated in FIGS. 10A to 10C, there is an effect that the flow of particles along the arc portion on the upper side of the first layer uppermost wire cross sections 751, 851, and 951 is less likely to be directed between the protrusion side surface 24a and each of the first layer uppermost wire cross sections 751, 851, and 951.

### REFERENCE SIGNS LIST

10 Coil device
20, 520, 620 First magnetic material portion
22 Plate-shaped portion
22 Plate-shaped portion side surface
22b Plate-shaped portion bottom surface
22c Plate-shaped portion upper surface
24, 524, 624 Protrusion
524ab Step surface
24a, 524a, 624a Protrusion side surface
24c, 524c, 624c Protrusion tip
30 Second magnetic material portion
40 Wire
40a Winding axis
41 Wire end portion
42, 142, 242, 342, 442, 542, 642 Winding portion
91, 92, 93, 94, 552, 553, 554, 652, 653, 654 Wire cross section
50, 150, 250, 350, 450, 550, 650 First layer
51, 251, 351, 451, 551, 651, 751, 851, 951 First layer uppermost wire cross section
52 First layer second-stage wire cross section
53 First layer third-stage wire cross section
54 First layer fourth-stage wire cross section
60, 260, 260, 360, 460 Second layer
61, 161, 261, 361, 461 Second layer uppermost wire cross section
62 Second layer second-stage wire cross section
63 Second layer third-stage wire cross section
64 Second layer fourth-stage wire cross section
70, 170, 270, 370, 470 Third layer
71, 171, 271, 371, 471 Third layer uppermost wire cross section
72 Third layer second-stage wire cross section
73 Third layer third-stage wire cross section
74 Third layer fourth-stage wire cross section
80, 180, 280, 380, 480 Fourth layer
81, 181, 281, 381, 481 Fourth layer uppermost wire cross section
82 Fourth layer second-stage wire cross section
83 Fourth layer third-stage wire cross section
84 Fourth layer fourth-stage wire cross section
751c, 851c, 951c Center
90 Fifth layer
D1 First direction
D2 Second direction

What is claimed is:

1. A coil device comprising:
a first magnetic material portion containing a magnetic material and having a plate-shaped portion and a protrusion protruding from the plate-shaped portion;
a wire having a winding portion including a conductor portion and an insulating coating portion covering the conductor portion and forming a winding layer wound around the protrusion; and
a second magnetic material portion containing a magnetic material and a resin and covering at least the winding portion and the protrusion of the first magnetic material portion,
wherein a first layer uppermost wire cross section located farthest from the plate-shaped portion among wire cross sections included in a first layer directly wound around the protrusion in the winding portion includes a portion farther from the plate-shaped portion as compared with a protrusion tip located farthest from the plate-shaped portion of the protrusion, and the coating portion in the first layer uppermost wire cross section is in contact with the protrusion, in a predetermined cross section including a winding axis of the winding portion in which the wire cross sections, which are cross sections of the wire, are observed.

2. The coil device according to claim 1, wherein the protrusion tip is farther from the plate-shaped portion as compared with a center of the first layer uppermost wire cross section.

3. The coil device according to claim 1, wherein a second layer uppermost wire cross section located farthest from the plate-shaped portion among the wire cross sections included in a second layer wound around the protrusion while overlapping the first layer in the winding portion is closer to the plate-shaped portion than the first layer uppermost wire cross section.

4. The coil device according to claim 1, wherein the first layer uppermost wire cross section is located farthest from the plate-shaped portion among all the wire cross sections included in the winding portion.

5. The coil device according to claim 1, wherein the first layer uppermost wire cross section is closest to the winding axis among the wire cross sections included in the first layer.

6. The coil device according to claim 1, wherein a protrusion side surface surrounding the periphery of the winding axis in the protrusion is inclined so as to approach the winding axis as being farther from the plate-shaped portion, and the wire cross sections included in the first layer are disposed along an inclination of the protrusion side surface.

7. The coil device according to claim 1, wherein a thickness of the second magnetic material portion covering the protrusion tip along a direction away from the plate-shaped portion is twice or less an average diameter of the wire cross sections.
